(19) United States
(12) Patent Application Publication
(10) Pub. No.: US 2015/0254952 A1
(43) Pub. Date: Sep. 10, 2015

(54) Platform of Smart Security Protection Integrated System

(71) Applicants: KANG CHAO, Taipei City (TW); YUNG TAI CHAO, Taoyuan County (TW)

(72) Inventors: KANG CHAO, Taipei City (TW); YUNG TAI CHAO, Taoyuan County (TW)

(21) Appl. No.: 14/326,436

(22) Filed: Jul. 8, 2014

(30) Foreign Application Priority Data
Mar. 4, 2014 (TW) 103203635

(51) Int. Cl. G08B 17/10; A62C 37/38; G08B 27/00; A62C 13/78; G08B 17/12; H04N 7/18

(52) U.S. Cl. CPC G08B 17/10; G08B 17/125; H04N 7/183; H04N 7/188; G08B 27/001; A62C 13/78; A62C 37/38

(57) ABSTRACT

A platform of a smart security protection integrated system includes a fire extinguishing device, a security notifying device, a communication transmission device, an automatic moving device, and a detecting device. The fire extinguishing device has a fire extinguisher cylinder and a nozzle that is able to target a fire source to spread fire extinguisher agents. The security notifying device is set in the platform and has an infrared night-vision camera for active detection and video recording. The communication transmission device is set in the platform and has a Wi-Fi signal transmitter and a GSM signal transmitter to transmit videos recorded by the security notifying device to relevant emergency personnel. The automatic moving device is set on the exterior of the platform to enable automatic multi-directional movement and automatic obstacle avoidance for the platform. The detecting device is set in the platform and has an infrared thermal imager, a high resolution video system, and a gas detection system to detect if the environment is abnormal, to send an alarm, and to transmit video to relevant emergency personnel. The platform utilizes the above features to achieve the functions of automatic controlling and monitoring, automatic fire extinguishing, automatic reporting, so as to improve the efficiency of fire reporting and responding.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

This invention relates to a smart security protection integrated system and, in particular, to a platform for a smart security protection integrated system, which comprises the functions of fire extinguishment, security, communication transmission, automatic movement, and detection.

2. Description of Related Arts

Based on previous regulations, residential houses did not have to set up an automatic fire alarm system. Current regulations require residential houses to have a house alarm, usually a smoke detector. Unfortunately, when no one is home, there is no one to notice if the house alarm turns on. Therefore, it has become important to be able to automatically, actively, and rapidly report to emergency personnel at the time when damage is occurring. Also, house fires often happen at night when people are sleeping Many persons are killed due to not knowing the ways to evacuate because they are scared or panic during a house fire. The system that is the subject of this patent is able to quickly alert and effectively guide and evacuate people from a house fire; people are able to act to escape a house fire based on the guidance of the system.

Security protection for areas of public use should have specific automatic fire alarm systems and relative fire-fighting equipment and evacuation equipment according to their respective fire and building codes.

A property owner often turns off the fire alarm control panel because such automatic alarm device often sends out a false positive signal, or the automatic alarm device is damaged due to mismanagement and maintenance issues and does not function when there is a fire.

A traditional “R-type” fire alarm control panel is able to display the triggered detectors on the fire alarm control panel, which helps to identify the origin of fire. However, such useful information can only be seen in the central control room. Other personnel in the field who could use the information cannot receive the information. In addition to the high cost of the “R-type” fire alarm control panel, most areas use a “P-type” fire alarm control panel. When a “P-type” fire alarm control panel is triggered, it only indicates the area or floor where there is a fire; it does not provide a precise location. Thus, a “P-type” fire alarm system is even less reliable than a “R-type” system to identify the exact origin of fa ire. Only positive detection, fast information transmission, and instant effective fire extinguishment can decrease the losses of life and property.

When a fire breaks out in a large building, such as a factory, warehouse, or workshop, a fire can easily expand out and spread because of the large space and obstruction of fire prevention designs by the production lines and equipment. Besides, firefighting equipment in a factory is mostly fire extinguishers and fire hydrants, which both types of firefighting equipment are passive firefighting equipment; and if there is water reactive substances or other flammable substances stored in the factory, water may not be an effective firefighting material. Firefighting equipment located at a factory also require well-trained personnel to operate the equipment for the equipment to be effective for fire extinguishment; when there is emergency, these personnel may panic and forget the main points of operation of the equipment. Reliance on an active protection platform to actively extinguish fire can stop the fire from spreading.

The current mandatory residential alarms for regular residential homes do not contain any device to transmit a signal to personnel in the field, who then cannot effectively take care of the fire in the time. If no one is in the house when a fire alarm is triggered, even with the connection of the security system, it is usually too late when the responders arrive at the house. Although there are automatic fire alarm equipment for public use buildings, only those in the area or floor will be alerted by the fire alarm control panel and the correct message cannot be effectively sent to nearby relatives or residents, property owners, or the fire department, nor can instructions be sent for security and rescue procedures. As a result, as rescuers arrive at the site, they can only ask earlier arriving personnel or other witnesses what occurred to understand the condition of fire. Therefore fire fighters may have to conduct rescue operations at the dangerous area of a fire without knowing the origin of fire or of any possible danger, which not only wastes time, but also puts the lives of fire fighters and rescuers.

As a fire happens, because of the urgent situation or suddenly awakening from sleep, people often are confused and still half asleep when awakened by a fire, and even forget to assist or remind nearby family and friends to evacuate, which lets the disaster to expand and causes more loss of life. If there is a system capable to suggest a way to evacuate and shelter with customized announcements for various circumstances, it will help people to evacuate a fire and to quickly find shelter.

Current fire safety equipment such as fire extinguishers and indoor hydrants, all require people to operate the equipment to suppress spreading and expanding of the early fire. However, fire usually spreads at the place where no one is present and/or where the equipment cannot be effectively used. Automatic fire extinguishing equipment of current fire safety equipment like the automatic sprinkler system that is able to automatically extinguish a fire, is called “active fire extinguishing equipment,” which has a good protective function. However, the number parts of this kind of automatic fire extinguishing equipment are numerous and vast, such as sprinkler heads, branch pipes, main pipes, water storage tank, pumps, and pressure start equipment. The system is very costly and its protection is great. The area protected is pinpoint protection, which means there will be blind spots within the protection area that cannot be covered fully. Besides, if the equipment is not installed well or there has been damage while decorating or redecorating the interior, the sprinkler head or system can easily be damaged. Poor care and maintenance or lack of repair without restoring the flow detecting equipment could cause failure the automatic fire extinguishing system if a fire breaks out. Therefore, the producing of full area covering, active detecting smart security protection equipment will help the effectiveness of fast fire extinguishment of a fire.

Although current security system service providers offer anti-theft security service, however when fire breaks out, the security, as they receive the message, need a period of time to arrive at the site, but they are not able to rapidly arrive at the site of the fire to conduct early fire extinguishment and suppression.

Furthermore, the nation is gradually transforming into an aging society where home protection and senior care have become an important issue now. If hazard prevention and rescue equipment can be coupled with home senior care equipment, such equipment can not only make hazard prevention more effective, but also achieve the goal of good senior care.

Therefore, the way to create a fire safety protection and hazard prevention integrated system with modularized design, which is able to provide multiple active functions, able to actively rapidly conduct fire extinguishment to avoid the expansion of a hazard when fire or an urgent disaster occurs, and is able to allow the users to evacuate sooner and inform relative rescuing department and personnel with the fastest way to increase security protectiveness and reduce the losses of property and lives, are the objectives of the present invention.

### SUMMARY OF THE PRESENT INVENTION

The most important key of a fire safety protection is early detection, fast approach to the problem, alarm, and fast fire extinguishment. One objective of the present invention is to provide a fire safety platform integrated system, mainly having detection function, fire extinguishment function, security function, communication transmission function, and automatic moving function. When fire happens, in the early stage the fire detecting device detects a signal of fire; the present platform is able to immediately automatically move to the area where the fire occurs. When it arrives in the area where the fire occurred, it can identify the correct spot of the fire with the infrared thermal imager and instantly transmit information of the fire site to the manager's cell phone or control center. At the moment the system is able to apply automatic or manual mode to control the fire extinguishing system of the platform to conduct fire extinguishment. The present platform is able to move and patrol at normal times. It can also carry broadcasting synchronous controlling devices and senior caring devices, so as to achieve multiple functions of automatic monitor, automatic fire extinguishment, automatic report, to enhance the efficiency of fire reporting and responding.

In order to accomplish the above objects, the present invention provides a platform of a smart security protection integrated system; the platform comprises a fire extinguishing device, a security notifying device, a communication transmission device, an automatic moving device, and a detecting device. The fire extinguishing device is set in the platform, wherein the fire extinguishing device has a fire extinguisher cylinder and a nozzle that is horizontally moveable; the nozzle connects to the fire extinguisher cylinder and the nozzle is extended to the outside of the platform; the contents of the fire extinguisher cylinder include fire extinguisher agents; the nozzle can target a fire source and spread fire extinguisher agents. The security notifying device is set in the platform and has an infrared night-vision camera for active detection and video recording. The communication transmission device is set in the platform and has a Wi-Fi signal transmitter and a GSM signal transmitter to transmit videos recorded by the security notifying device to relative personnel. The automatic moving device is set at the exterior of the platform to enable automatic multi-directional movement and automatic obstacle avoidance for the platform. The detecting device is set in the platform and has an infrared thermal imager, a high resolution video system, and a gas detection system to detect if there are abnormalities in the environment , to send an alarm, and to transmit video to relevant personnel.

In another embodiment, it further comprises a broadcasting synchronous controlling device, a reporting device, and a senior caring device. The broadcasting synchronous controlling device is able to send out broadcasting messages to notify relevant on site personnel and report to the fire department when the platform detects the a fire. The reporting device is set in the platform to call the numbers of the fire department branch and security personnel automatically and inform them of the location of the fire with synthesized speech. The senior caring device electronically connects to the communication transmission device; the platform has a blood pressure and blood sugar measuring equipment being able to measure and record the measured results, and if the measured result is higher than a predetermined value, the platform will send out message to remind relevant personnel. Besides, the automatic moving device is able to move in multiple directions, using rail wheels and rails. The rail wheels are set on or under the exterior of the platform; the rails are set on the floor, ceiling, or any direction, for the rail wheels of the platform to move according to the rails.

### BRIEF DESCRIPTION OF THE DRAWINGS

FIG. 1 is a component diagram of the platform of a smart security protection integrated system according to a first preferred embodiment of the present invention.

FIG. 2 is a schematic structural view of the platform of the smart security protection integrated system according to the above preferred embodiment of the present invention.

FIG. 3 is a component diagram of the platform of a smart security protection integrated system according to a second preferred embodiment of the present invention.

FIG. 4 is a schematic structural view of the platform of a smart security protection integrated system according to a third preferred embodiment of the present invention.

### DETAILED DESCRIPTION OF THE PREFERRED EMBODIMENT

The following describes ways to embody the present invention with particular embodiments. Those skilled in the art can easily understand other advantages and functions of the present invention through this disclosed content.

The following describes the embodiments of the present invention referring to the drawings. It should be noted that the following drawings are simplified sketch drawings, which utilize sketching to illustrate basic ideas of the present invention; therefore, the drawings only show structures that relate to the present invention, but draw according to the numbers, shapes, and size of the parts for actual embodiments. Each of the forms, numbers, and ratios for the actual embodiment is not limited to the drawings and may change based on the needs of actual design, which must be declared first.

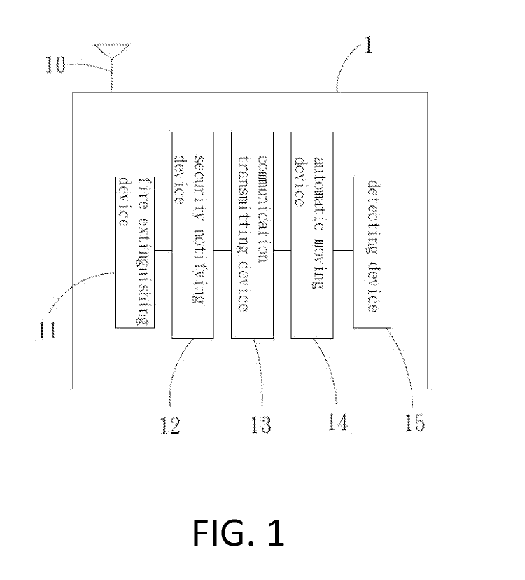

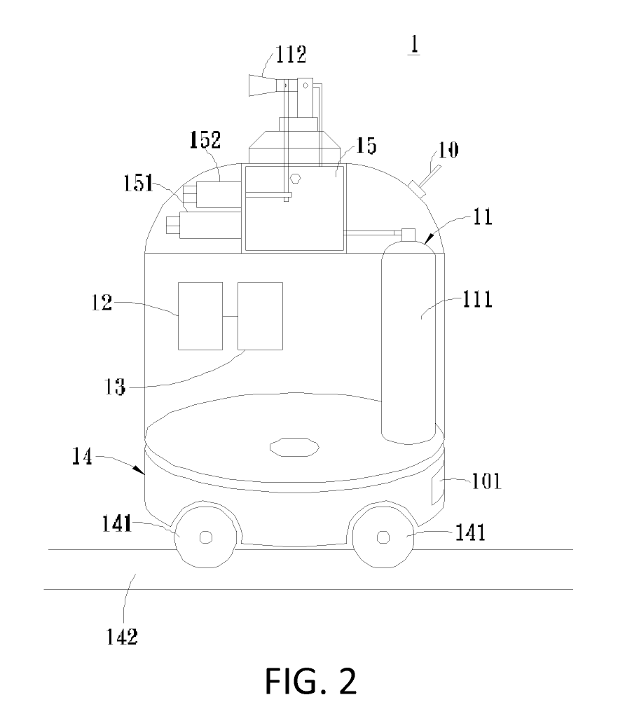

Referring to FIG. 1 and FIG. 2, a component diagram and a schematic structural view of a first preferred embodiment of the platform of smart security protection integrated system of the present invention is shown. As is shown in FIGS. 1 and 2, the platform 1 of a smart security protection integrated system of the present invention has an antenna 10. The antenna 10 is to be used for remote monitor transmission. The platform 1 comprises a fire extinguishing device 11, a security notifying device 12, a communication transmitting device 13, an automatic moving device 14, and a detecting device 15.

The fire extinguishing device 11 is set inside the platform 1. The fire extinguishing device 11 has a fire extinguisher cylinder 111 and a nozzle 112 that is horizontally moveable. The nozzle 112 connects to the fire extinguisher cylinder 111 and extends to the outside of the platform. The contents of the fire extinguisher cylinder 111 include fire extinguisher agents. The nozzle 112 can target a fire source and spread fire extinguisher agents. The fire extinguisher agents may selectively apply various ingredients, such as ABC dry chemical, BC dry chemical, class D powder, gas extinguishing, or strengthened wet chemical, and methods of shooting based on the circumstance. The fire extinguishing device 11 is able to directly aim the fire source to conduct shooting, and is able to control the nozzle 112 to move left and right to expand the area of the fire extinguishment. Besides, the platform 1 may also automatically adjust the distance of the platform 1 and the place of fire source through the distance detecting equipment to increase the efficiency of fire extinguishing.

The security notifying device 12 is set inside the platform 1 and has an infrared night-vision camera for active detection and video recording. The communication transmitting device 13 is set inside the platform 1 and has a Wi-Fi signal transmitter and a GSM signal transmitter to transmit videos recorded by the security notifying device 12 to relevant emergency personnel. The automatic moving device 14 is set at the exterior of the platform 1 to enable automatic movement and automatic obstacle avoiding for the platform 1. The detecting device 15 is set inside the platform 1 and has an infrared thermal imager 151, a high resolution video system 152, and a gas detection system to detect if there are abnormalities in the environment, to send an alarm, and to transmit video to relevant emergency personnel. The automatic moving device 14 further comprises rail wheels 141 and rails 142. In the first preferred embodiment, the rail wheels 141 are set under the exterior of the platform 1; the rails 142 are set on the floor or all directions for the rail wheels 141 of the platform 1 to move according to the rails 142.

Specifically with the above devices the platform 1 is enabled to automatically move and detect, record video and transmit a signal. Therefore, when the platform 1 is practicing patrol, once it detects any abnormal situation, it can send message an image to relevant emergency personnel. Also because it has an infrared thermal imager 151, it is able to conduct detection in low illuminant or dark environment and send the image message back to an external control center through the antenna 10. Also when the platform 1 finds a suspicious person or object in its guarded area, it can approach to warn or take a picture. If the suspicious person tries to attack the platform 1, it is able to protect itself by shooting red liquid agent through the nozzle 112. Besides, the rails 142 may further be distinguished to be ground surface rails, sidewall rails, suspending rails, hidden rails, or other rails with various structural designs, which may all achieve the purpose of automatic moving. Further, the platform 1 has a charger 101 that is able to directly connect to external power sources to recharge.

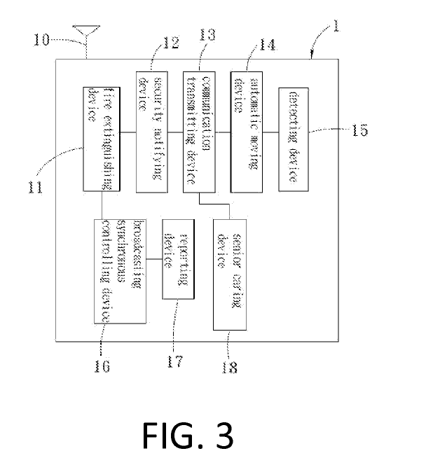

Referring to FIG. 3, a component diagram of a second preferred embodiment of the platform of a smart security protection integrated system of the present invention is disclosed. As FIG. 3 shows, in the second embodiment, the platform 1 of a smart security protection integrated system of the present invention, besides the fire extinguishing device 11, the security notifying device 12, the communication transmitting device 13, the automatic moving device 14, and the detecting device 15, may be additionally equipped with a broadcasting synchronous controlling device 16, a reporting device 17, and a senior caring device 18. The broadcasting synchronous controlling device 16 has remote microphones and speakers for the platform 1 to broadcast a message to warn the relevant emergency personnel on site and report to the fire department when the a fire has been detected. The reporting device 17 is set inside the platform to call the numbers of the fire department branch and security personnel automatically and, using synthesized speech, inform them of the location of a fire. The senior caring device 18 electronically connects to the communication transmission device 13. The platform 1 has a blood pressure and blood sugar measuring equipment that are able to measure and record the measured result, and if the measured result is higher than the predetermined value, the communication transmission device 13 will send out message to notify relevant emergency personnel.

Specifically, when the platform 1 confirms there is a fire, before the platform 1 arrives at the site of fire, the broadcasting synchronous controlling device 16 will automatically send out a broadcasting signal to suggest to on site personnel to pay attention to the relative emergency responses. Relevant emergency personnel may also use the remote microphone and the speakers of the platform 1 to report or directly give command orders and notes. The reporting device 17 will automatically call the numbers of the fire department and security personnel and, using with synthesized speech, inform them of the location of a fire. The reporting device 17 may also verbally inform the residents at the location of the fire and other relevant information. The reporting device 17 also allows inputting of prerecorded voices for various places of use; when the place of fire has been confirmed, it may broadcast the directions and the safest path to use to evacuate. Further, the senior caring device 18 comprises a pill case set on the platform 1 and allows preset time for reminder, to a senior person, to remind the senior person to take his/her prescription.

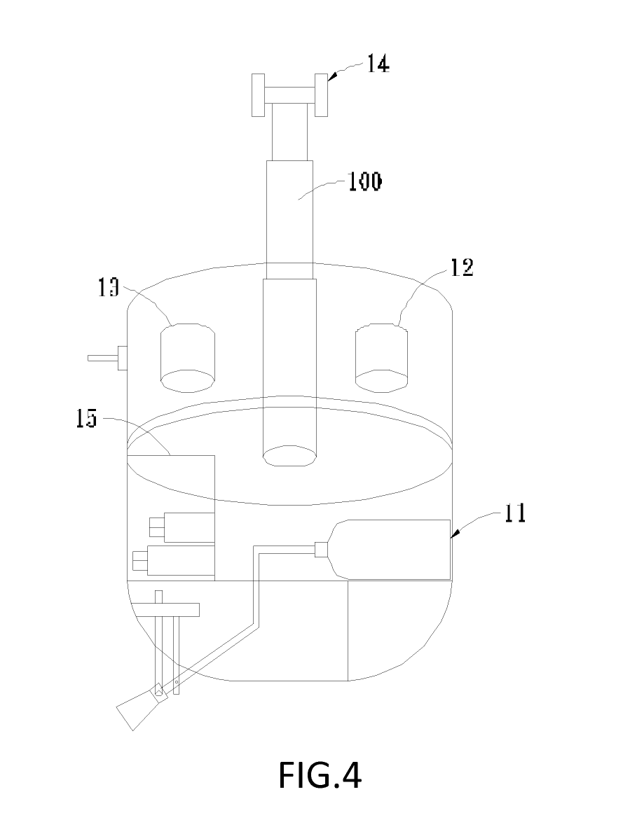

Lastly, referring to FIG. 4, FIG. 4 discloses a schematic structural view of a third preferred embodiment of the platform of a smart security protection integrated system of the present invention. As FIG. 4 shows, the platform 1 of a smart security protection integrated system of the present invention, besides being set to move on the ground as shown in the first embodiment, may also be set on the ceiling or multi-directional setting, utilizing the rail system. In this embodiment, a suspending rail that the platform 1 is able to move according to the rails is set on the ceiling. There is also a lever 100 additionally set to enable the platform 1 to move up and down. The platform 1 comprises a fire extinguishing device 11, a security notifying device 12, a communication transmitting device 13, an automatic moving device 14, and a detecting device 15. Therefore it can also achieve the purposes mentioned in the first embodiment.

Comparing to the prior art, all devices of the platform of a smart security protection integrated system of the present invention are based on modularity design that allows the system to be assembled from various devices based on different needs. The platform is able to automatically move and detect, to automatically avoid obstacles, as to move on the ground or ceiling, and further able improve hazard monitoring and prevention.

Although the above descriptions and drawings disclose preferred embodiments of the present invention, it should be obvious to persons skilled in the art that additions, modifications, and alternatives may apply on the preferred embodiment of the present invention without exceeding the scope and spirit of the present invention. One regularly skilled in the art of the field of the present invention will be able to understand that the present invention can be applied in various modifications of forms, structures, settings, ratios, materials, parts, and components. Therefore, the embodiment that has been disclosed here in the present specification should be considered for describing the present invention without limiting the present invention. The scope of the present invention shall be defined by the patent claims as attached below and comprise its legitimate equivalences without being limited in the above description.

What is claimed is:

1. A platform of a smart security protection integrated system, wherein said platform has an antenna and comprises:
a fire extinguishing device, which is set in the platform, wherein said fire extinguishing device has a fire extinguisher cylinder and a nozzle that is horizontally moveable; said nozzle connects to said fire extinguisher cylinder and said nozzle is extended to the outside of the platform; the contents of said fire extinguisher cylinder include one or more fire extinguisher agents; said nozzle can target a fire source and spread said one or more fire extinguisher agents;
a security notifying device, which is set in the platform and has an infrared night-vision camera for active detection and video recording;
a communication transmission device, which is set in the platform and has a Wi-Fi signal transmitter and a GSM signal transmitter to transmit videos recorded by said security notifying device to relevant emergency personnel;
an automatic moving device, which is set on the exterior of the platform to enable automatic multi-directional movement and automatic obstacle avoidance for the platform; and
a detecting device, which is set in the platform and has an infrared thermal imager, a high resolution video system, and a gas detection system to detect if there is any abnormality in the environment, to send an alarm, and to transmit video to relevant emergency personnel.

2. The platform of a smart security protection integrated system according to claim 1 further comprising a broadcasting synchronous controlling device, which is able to send out broadcasting messages to notify relevant on site personnel and report to a fire department when the platform detects a fire.

3. The platform of a smart security protection integrated system according to claim 2, wherein said broadcasting synchronous controlling device comprises a remote microphone and a speaker.

4. The platform of a smart security protection integrated system according to claim 1 further comprising a reporting device, which is set in the platform for the purpose of calling the numbers of the fire department and security personnel automatically and, using synthesized speech, to inform them about the location of a fire.

5. The platform of a smart security protection integrated system according to claim 1 further comprising a senior caring device, which electronically connects to said communication transmission device; said platform further having a blood pressure and blood sugar measuring equipment to measure and record the measured result, and if the measured result is higher than the predetermined value, wherein said communication transmission device on said platform will send out message to notify relevant emergency personnel of the result.

6. The platform of a smart security protection integrated system according to claim 5, wherein said senior caring device further comprises a pill case; wherein said pill case is set on said platform; and wherein said platform has a method to remind an individual medicine use based on a set schedule.

7. The platform of a smart security protection integrated system according to claim 1, wherein said automatic moving device further comprises rail wheels and rails;
wherein said rail wheels are set on or under the exterior of the platform; wherein said rails are set on the floor, ceiling, or multi-directional, for said rail wheels of the platform to move according to said rails.

8. The platform of a smart security protection integrated system according to claim 1, wherein the platform further comprises a charger to directly connect to an external power source to conduct recharging.
